(19) United States
(12) Patent Application Publication
(10) Pub. No.: US 2003/0030638 A1
(43) Pub. Date: Feb. 13, 2003

(54) Method and apparatus for extracting information from a target area within a two-dimensional graphical object in an image

(76) Inventors: Karl Astrom, Lund (SE); Andreas Bjorklund, Lund (SE); Martin Sjolin, Lund (SE); Markus Andreasson, lund (SE)

Correspondence Address: NORMAN H. ZIVIN, RICHARD S. MILNER, Cooper & Dunham LLP, 1185 Avenue of the Americas, New York, NY, 10036, US

(21) Appl. No.: 10/165,653

(22) Filed: Jun. 7, 2002

Related U.S. Application Data
(60) Provisional application No. 60/298,512, filed on Jun. 15, 2001.

(30) Foreign Application Priority Data
Jun. 7, 2001 (SE) 0102021-3

(51) Int. Cl. G06T 17/00

(52) U.S. Cl. 345/420

(57) ABSTRACT

A method is presented for extracting information from a target area within a two-dimensional graphical object having a plurality of predetermined features with known characteristics in a first plane. An image is read where the object is located in a second plane, which is a priori unknown. A plurality of candidates to the features in the second plane are identified in the image. A transformation matrix for projective mapping between the second and first planes is calculated from the identified feature candidates. The target area of the object is transformed from the second plane into the first plane. Finally, the target area is processed so as to extract the information.

### FIELD OF THE INVENTION

Generally speaking, the present invention relates to the fields of computer vision, digital image processing, object recognition, and image-producing hand-held devices. More specifically, the present invention relates to a method and an apparatus for extracting information from a target area within a two-dimensional graphical object having a plurality of predetermined features with known characteristics in a predetermined first plane.

### BACKGROUND OF THE INVENTION

Computer vision systems for object recognition, image registration, 3D object reconstruction, etc., are known from e.g. U.S. Pat. Nos. B1-6,226,396, B1-6,192,150 and B1-6,181,815. A fundamental problem in computer vision systems is determining the correspondence between two sets of feature points extracted from a pair of images of the same object from two different views. Despite large efforts, the problem is still difficult to solve automatically, and a general solution is yet to be found. Most of the difficulties lie in differences in illumination, perspective distortion, background noise, and so on. The solution will therefore have to be adapted to individual cases where all known information has to be accounted for.

In recent years, advanced computer vision systems have become available also in hand-held devices. Modern hand-held devices are provided with VGA sensors, which generate images consisting of 640×480 pixels. The high resolution of these sensors makes it possible to take pictures of objects with enough accuracy to process the images with satisfying results.

However, an image taken from a hand-held device gives rise to rotations and perspective effects. Therefore, in order to extract and interpret the desired information within the image, a projective transformation is needed. Such a projective transformation requires at least four different point correspondences where no three points are collinear.

### SUMMARY OF THE INVENTION

In view of the above, an objective of the invention is to facilitate detection of a known two-dimensional object in an image so as to allow extraction of desired information which is stored in a target area within the object, even if the image is recorded in an unpredictable environment and, thus, at unknown angle, rotation and lighting conditions.

Another objective is to provide a universal detection method, which is adaptable to a variety of known objects with a minimum of adjustments.

Still another objective is to provide a detection method, which is efficient in terms of computing power and memory usage and which, therefore, is particularly suitable for hand-held image-recording devices.

Generally, the above objectives are achieved by a method and an apparatus according to the attached independent patent claims.

Thus, according to the invention, a method is provided for extracting information from a target area within a two-dimensional graphical object having a plurality of predetermined features with known characteristics in a first plane. The method involves:

reading an image in which said object is located in a second plane, said second plane being a priori unknown;

in said image, identifying a plurality of candidates to said predetermined features in said second plane;

from said identified plurality of feature candidates, calculating a transformation matrix for projective mapping between said second and first planes;

transforming said target area of said object from said second plane into said first plane, and

processing said target area so as to extract said information.

The apparatus according to the invention may be a hand-held device that is used for detecting and interpreting a known two-dimensional object in the form of a sign in a single image, which is recorded at unknown angle, rotation and lighting conditions. To locate the known sign in such an image, specific features of the sign are identified. The feature identification may be based on the edges of the sign. This provides for a solution, which is adaptable to most already existing signs, since the features are as general as possible and common to most signs. To find lines that are based on the edges of the sign, an edge detector based on the Gaussian kernel may be used. Once all edge points have been identified, they will be grouped together into lines. The Gaussian kernel may also be used for locating the gradient of the edge points. The corner points on the inside of the edges are then used as feature point candidates. These corner points are obtained from the intersection of the lines, which run along the edges.

In an alternative embodiment, if there are other very significant features in the sign (e.g., dots of a specific gray-scale, color, intensity or luminescence), these can be used instead of or in addition to the edges, since such significant features are easy to detect.

Once a specific amount of feature candidates have been identified, an algorithm, for example based on the algorithm commonly known as RANSAC, may be executed in order to verify that the features are in the right configuration and to calculate a transformation matrix. After ensuring that the features are in the proper geometric configuration, any target area of the object can be transformed, extracted and interpreted with, for example, an OCR or a barcode interpreter or a sign identificator.

Other objectives, characteristics and advantages of the present invention will appear from the following detailed disclosure, from the attached subclaims as well as from the drawings.

### BRIEF DESCRIPTION OF THE DRAWINGS

A preferred embodiment of the present invention will now be described in more detail, reference being made to the enclosed drawings, in which:

FIG. 1 is a schematic view of an image-recording apparatus according to the invention in the form of a hand-held device,

FIG. 1a is a schematic view of the image-recording apparatus of FIG. 1 as well as a computer environment, in which the apparatus may be used,

FIG. 2 is a block diagram, which illustrates important parts of the image-recording apparatus shown in FIG. 1,

FIG. 3 is a flowchart diagram which illustrates the overall steps, which are carried out through the method according to the invention,

FIG. 4 is a flowchart diagram which illustrates one of the steps of FIG. 3 in more detail,

FIG. 5 is a graph for illustrating a smoothing and derivative mask, which is applied to a recorded image during one step of the method illustrated in FIGS. 3 and 4, and

FIGS. 6-17 are photographs illustrating the processing of a recorded image during different steps of the method illustrated in FIGS. 3 and 4.

### DETAILED DISCLOSURE OF AN EMBODIMENT

The rest of this specification has the following disposition:

In section A, a general overview of the method and apparatus according to an embodiment is given.

To better understand the material covered by this specification, an introduction to projective geometry in terms of homogeneous notation and camera projection matrix is described in section B.

Section C provides an explanation of how to obtain the transformation matrix or homography matrix, once feature point correspondences have been identified.

An explanation of which kind of features should be chosen and why is found in Section D.

Section E describes a line-detecting algorithm.

Section F provides a description of the kind of information that can be obtained from lines.

Once the feature points have been identified, the homography matrix can be computed, which is done using a RANSAC algorithm, as explained in Section G.

Section H describes how to extract the desired information from the target area.

Finally, section I addresses a few alternative embodiments.

A. General Overview

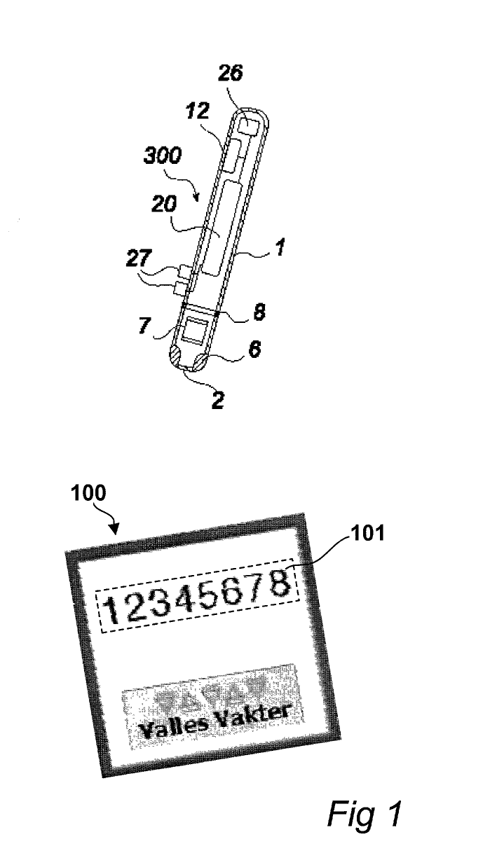

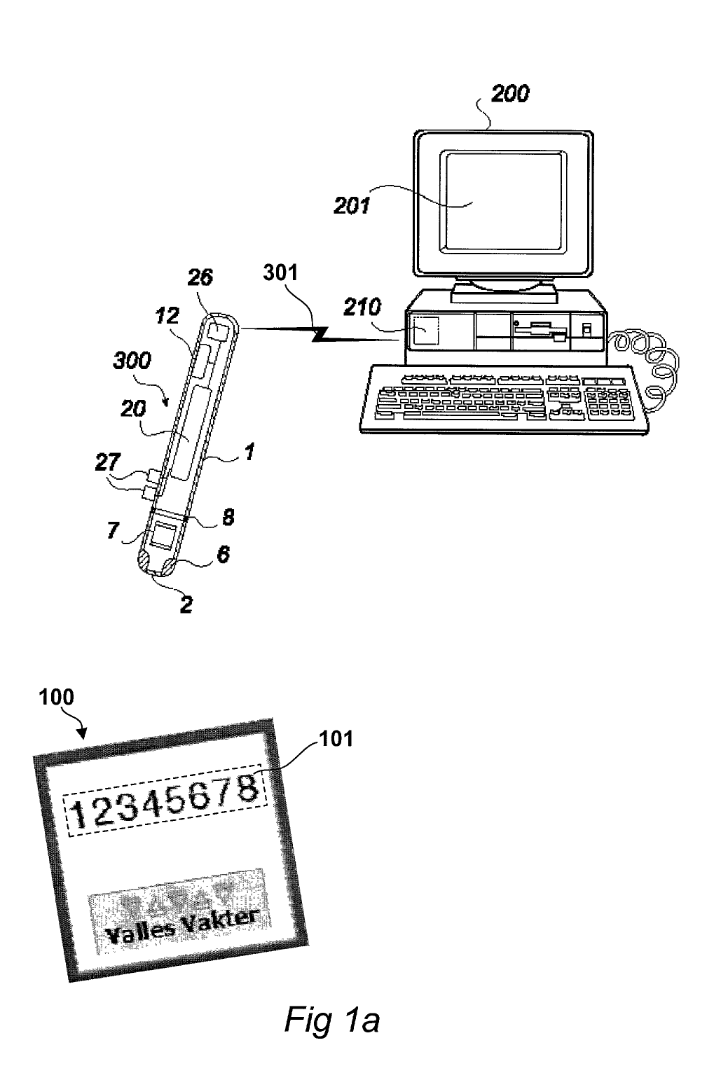

An embodiment of the invention will now be described, where the object to be recognized and read from is a sign 100, as shown at the bottom of FIG. 1. It is to be emphasized, however, that the invention is not limited to signs only. The sign 100 is intended to look as ordinary as any sign. The target area 101, from which information is to be extracted and interpreted, is the area with the numbers “12345678” and is indicated by a dashed frame in FIG. 1. As can be seen, the sign 100 does not hold very much information that can be used as features.

As with many other signs, the sign 100 is surrounded by a frame. The edges of this frame give rise to lines. The embodiment is based on using these lines as features. However, any kind of feature can be used as long as a total of at least four feature points can be distinguished. If the sign holds any special features (e.g., dots of a specific color), then these can be used instead of or in addition to the frame, since they are usually easier to detect.

FIG. 1 illustrates an image-producing hand-held device 300, which implements the apparatus according to the embodiment and by means of which the method according to the embodiment may be performed. The hand-held device 300 has a casing 1 having approximately the same shape as a conventional highlighter pen. One short side of the casing has a window 2, through which images are recorded for various image-based functions of the hand-held device.

Principally, the casing 1 contains an optics part, an electronics part and a power supply.

The optics part comprises a number of light sources 6 such as light emitting diodes, a lens system 7 and an optical image sensor 8, which constitutes the interface with the electronics part. The light emitting diodes 6 are intended to illuminate a surface of the object (sign) 100, which at each moment lies within the range of vision of the window 2. The lens system 7 is intended to project an image of the surface onto the light-sensitive sensor 8 as correctly as possible. The optical sensor 8 can consist of an area sensor, such as a CMOS sensor or a CCD sensor with a built-in A/D converter. Such sensors are commercially available. The optical sensor 8 may produce VGA images (“Video Graphics Array”) in 640×480 resolution and 24-bit color depth. Hence, the optics part forms a digital camera.

In this example, the power supply of the hand-held device 300 is a battery 12, but it can alternatively be a mains connection or a USB cable (not shown).

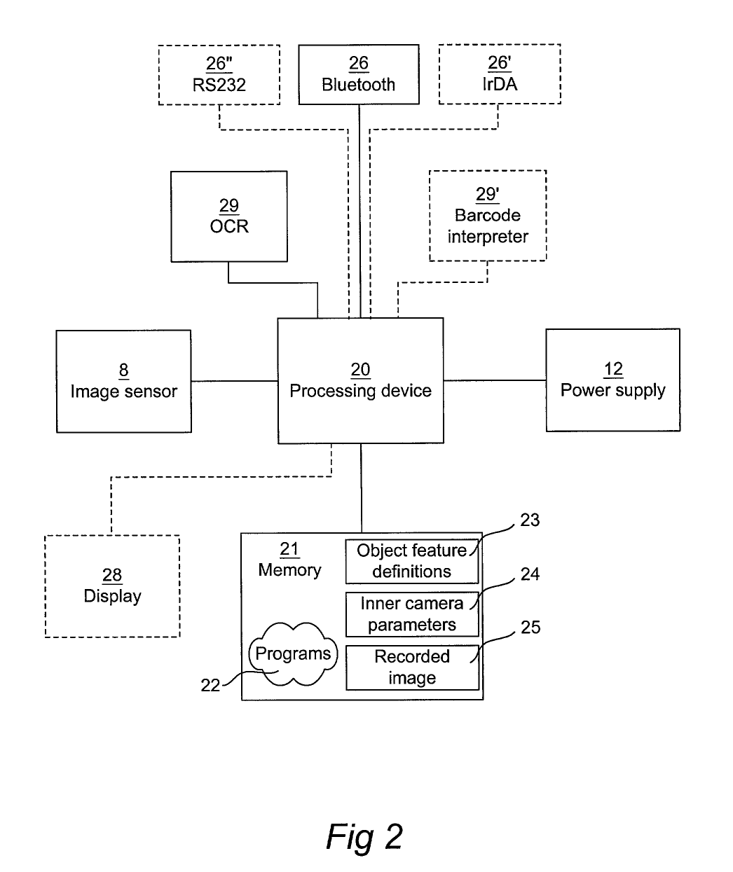

As shown in more detail in FIG. 2, the electronics part comprises a processing device 20 with storage means, such as memory 21. The processing device 20 may be implemented by a commercially available microprocessor such as a CPU (“Central Processing Unit”) or a DSP (“Digital Signal Processor”). Alternatively, the processing device 20 may be implemented as an ASIC (“Application-Specific Integrated Circuit”), a gate array, as discrete analog and digital components, or in any combination thereof.

The storage means 21 includes various types of memory, such as a work memory (RAM) and a read-only memory (ROM). Associated programs 22 for carrying out the method according to the preferred embodiment are stored in the storage means 21. Additionally, the storage means 21 comprises a set of object feature definitions 23 and a set of inner camera parameters 24, the purpose of which will be described in more detail later. Recorded images are stored in an area 25 of the storage means 21.

As shown in FIG. 1a, the hand-held device 300 may be connected to a computer 200 through a transmission link 301. The computer 200 may be an ordinary personal computer with circuits and programs, which allow communication with the hand-held device 300 through a communication interface 210. To this end, the electronics part may also comprise a transceiver 26 for transmitting information to/from the computer 200. The transceiver 26 is preferably adapted for short-range radio communication in accordance with, e.g., the Bluetooth standard in the 2.4 GHz ISM band (“Industrial, Scientific and Medical”). The transceiver can, however, alternatively be adapted for infrared communication (such as IrDA—“Infrared Data Association”, as indicated by broken lines at 26′) or wire-based serial communication (such as RS232, indicated by broken lines at 26″), or essentially any other available standard for short-range communication between a hand-held device and a computer.

The electronics part may further comprise buttons 27, by means of which the user can control the hand-held device 300 and in particular toggle between its different modes of functionality.

Optionally, the hand-held device 300 may comprise a display 28, such as a liquid crystal display (LCD) and a clock module 28′.

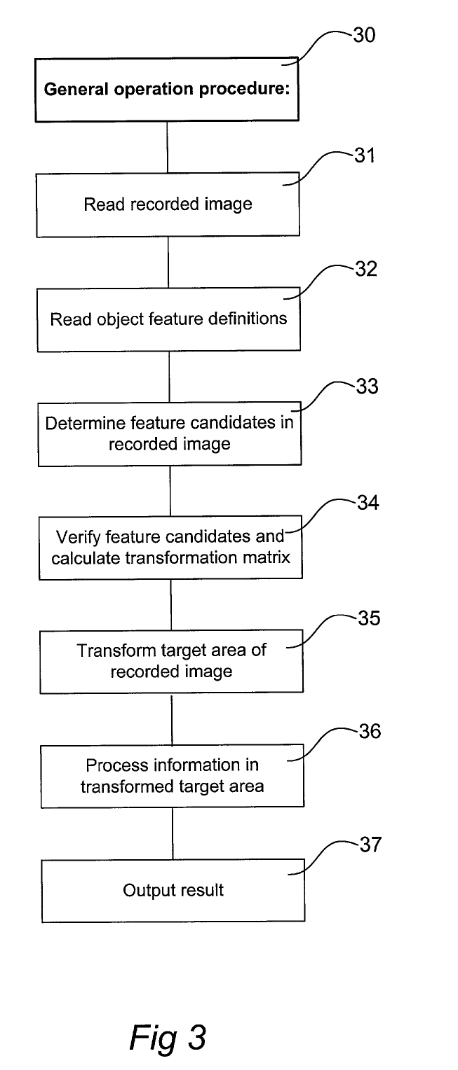

Within the context of the present invention, as shown in FIG. 3, the important general function of the hand-held device 300 is first to identify a known two-dimensional object 100 in an image, which is recorded by the hand-held device 300 at unknown angle, rotation and illumination (steps 31-33 in FIG. 3). Then, once the two-dimensional object has been identified in the recorded image, a transformation matrix is determined (step 34 in FIG. 3) for the purpose of projectively transforming (step 35 in FIG. 3) the target area 101 within the recorded image of the two-dimensional object 100 into a plane suitable for further processing of the information within the target area.

Simply put, the target area 101 is transformed into a predetermined first plane, which may be the normal plane of the optical input axis of the hand-held device 300, so that it appears that the image was recorded right in front of the window 2 of the hand-held device 300, rather than at an unknown angle and rotation.

The first plane comprises a number of features, which can be used for the transformation. These features may be obtained directly from the physical object 100 to be imaged by direct measurements at the object alone. Another way to obtain such information is to take an image of the object and measure at the image alone.

Finally, the transformed target area is processed through e.g. optical character recognition (OCR) or barcode interpretation, so as to extract the information searched for (steps 36 and 37 in FIG. 3). To this end, the embodiment comprises at least one of an OCR module 29 or a barcode module 29′. Advantageously, such modules 29 or 29′ are implemented as program code 22, which is stored in the storage means 21 and is executed by the processing device 20.

The extracted information can be used in many different ways, either internally in the hand-held device 300 or externally in the computer 200 after having been transferred across the transmission link 301.

Exemplifying but not limiting use cases include a custodian who verifies where and when during his night-shift that he was at different locations by capturing images of generally identical signs 100 containing different information when walking around the protected premises; a shop assistant using the hand-held device 300 for stocktaking purposes; tracking of goods in industrial areas; or for registering license plate numbers for cars and other vehicles.

The hand-held device 300 may advantageously provide other image-based services, such as scanner functionality and mouse functionality.

The scanner functionality may be used to record text. The user moves the input unit 300 across the text, which he wants to record. The optical sensor 8 records images with partially overlapping contents. The images are assembled by the processing device 20. Each character in the composite image is localized, and, using for instance neural network software in the processing device 20, its corresponding ASCII character is determined. The text converted in this way to character-coded format can be stored, in the form of a text string, in the hand-held device 300 or be transferred to the computer 200 across the link 301. The scanner functionality is described in greater detail in the Applicant's Patent Publication No. WO98/20446, which is incorporated herein by reference.

The mouse functionality may be used to control a cursor on the display 201 of the computer 200. When the hand-held device 300 is moved across an external base surface, the optical sensor 8 records a plurality of partially overlapping images. The processing device 20 determines positioning signals for the cursor of the computer 200 on the basis of the relative positions of the recorded images, which are determined by means of the contents of the images. The mouse functionality is described in greater detail in the Applicant's Patent Publication No. WO99/60469, which is incorporated herein by reference.

Still other image-based services may be provided by the hand-held device 300, for instance traditional picture or video camera functionality, drawing tool, translation of scanned text, address book, calendar, or email/fax/SMS (“Short Messages Services”) through a mobile telephone such as a GSM telephone (“Global System for Mobile communications”, not shown in FIG. 1).

B. Projective Geometry

This chapter introduces the main geometric ideas and notations that are required to understand the material covered in the rest of this specification.

Introduction

In Euclidian geometry, the pair of coordinates (x,y) in Euclidian space R² may represent a point in the real plane. Therefore it is common to identify a plane with R². Considering R² as a vector space, then the coordinates are identified as vectors. This section will introduce homogeneous representation for points and lines in a plane. The homogeneous representation provides a consistent notation for projective mappings of points and lines. This notation will be used to explain mappings between different representations of planes.

Homogeneous Coordinates

A line in a plane is represented by the equation ax+by+c=0, where different choices of a, b and c give rise to different lines. The vector representation of this line is l=(a,b,c)^{T}. On the other hand, the equation (ka)x+(kb)y+kc=0 also represents the same line for a non-zero constant k. Therefore the correspondence between lines and vectors are not one-to-one, since two vectors related by an overall scaling are considered to be equal. An equivalence class of vectors under this equivalence relationship is known as homogeneous vectors. The set of equivalence classes of vectors in R³−(0,0,0)^{T} forms the projective space p². The notation −(0,0,0)^{T} means that the vector (0,0,0)^{T} is excluded.

A point represented by the vector x=(x,y)^{T} lies on the line l=(a,b,c)^{T} if and only if ax+by+c=0. This equation can be written as an inner product of two vectors, (x,y,1)(a,b,c)^{T}=0. Here, the point is represented as a 3-vector (x,y,1) by adding a final coordinate of 1 to the 2-vector. Using the same terminology as above, we notice that (kx,ky,k)(a,b,c)^{T}=0, which means that the vector k(x,y,1) represents the same point as (x,y,1) for any non-zero constant k. Hence the set of vectors k(x,y,1)^{T} is considered to be the homogeneous representation of the point (x,y)^{T} in R². An arbitrary homogeneous vector representative of a point is of the form x=(x₁,x₂,x₃)^{T}.

This vector represents the point (x₁/x₃,x₂/x₃)^{T} in R², if X₃≠0.

A point represented as a homogeneous vector is therefore also an element of the projective space P². A special case of a point x=(x₁,x₂,x₃)^{T} in P² is when x₃=0. This does not represent a finite point in R². In P² these points are known as ideal points, or points at infinity. The set of all ideal points is represented by x=(x₁,x₂,0)^{T}. This set lies on a single line known as the line at infinity, and is denoted by the vector l_{∞=(}0,0,1)^{T}. By calculations, one verifies that

l_{∞}^{T}x=(0,0,1)(x₁,x₂,0)^{T}=0.

Homographies or Projective Mappings

When points are being mapped from one plane to another, the ultimate goal is to find a single function that maps every point from the first plane uniquely to a point in the other plane.

A projectivity is an invertible mapping h from P²→P² such that x₁, x₂ and x₃ lie on the same line if and only if h(x₁), h(x₂) and h(x₃) do (see Hartley, R., and Zissermann, A., “Multiple View Geometry in computer vision”, Cambridge University Press, 2000). A projectivity is also called a collineation, a projective transformation, or a homography.

This mapping can also be written as h(x)=Hx, where x, h(x) εP² and H is a non-singular 3×3 matrix. H is called a homography matrix. From now on we will denote x′=h(x), which gives us:

$$( \begin{matrix}{x}_{1}^{′} \\ {x}_{2}^{′} \\ {x}_{3}^{′}\end{matrix} ) = ( \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ) ( \begin{matrix}{x}_{1} \\ {x}_{2} \\ {x}_{3}\end{matrix} ) ,$$

or just x′=Hx.

Since both x′ and x are homogeneous representations of points, H may be changed by multiplying an arbitrary non-zero constant without altering the homography transformation. This means that H is only determined up to a scale. A matrix like this is called a homogeneous matrix. Consequently, H has only eight degrees of freedom, and the scale can be chosen such that one of its elements (e.g., h₉) can be assumed to be 1. However, if the coordinate origin is mapped to a point at infinity by H, it can be proven that h₉=0, and scaling H so that h₉=1 can therefore lead to unstable results. Another way of choosing a representation for a homography matrix is to require that |H|=1.

Camera Projection Matrix

A camera is a mapping from the 3D world to the 2D image. This mapping can be written as:

$$( \begin{matrix}x \\ y \\ z\end{matrix} ) = ( \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34}\end{matrix} ) ( \begin{matrix}X \\ Y \\ Z \\ 1\end{matrix} ) ,$$

or more briefly, x=PX. X is the homogeneous representation of the point in the 3D world coordinate frame. x is the corresponding homogeneous representation of the point in the 2D image coordinate frame. P is the 3×4 homogeneous camera projection matrix. For a complete derivation of P, see Hartley, R., and Zissermann, A., “Multiple View Geometry in computer vision”, Cambridge University Press, 2000, pages 139-144, where the camera projection matrix for the basic pinhole camera is derived. P can be factorized as:

P=KR[I|−t].

In this case, K is the 3×3 calibration matrix, which contains the inner parameters of the camera. R is the 3×3 rotation matrix and t is the 3×1 translation vector. This factorization will be used below.

On Planes

Suppose we are only interested in mapping points from the world coordinate frame that lie in the same plane π. Since we are free to choose our world coordinate frame as we please, we can for instance define π: Z=0. This reduces the equation above. If we denote the columns in the camera projection matrix with pᵢ, we get:

$$( \begin{matrix}x \\ y \\ 1\end{matrix} ) = \begin{matrix}[ {p}_{1} & {p}_{2} & {p}_{3} & {p}_{4} ]\end{matrix} ( \begin{matrix}X \\ Y \\ 0 \\ 1\end{matrix} ) = \begin{matrix}[ {p}_{1} & {p}_{2} & {p}_{3} & {p}_{4} ]\end{matrix} ( \begin{matrix}X \\ Y \\ 1\end{matrix} ) .$$

The mapping between the points x_{π}=(X,Y,1)^{T} on π, and their corresponding points on the image x′, is a regular planar homography x′=Hx_{π}, where H=[p₁ p₂ p₄].

Additional Constraints

If we have a calibrated camera, the calibration matrix K will be known, and we can obtain even more information. Since

P=KR[I|−t],

and the calibration matrix K is invertible, we can get:

K⁻¹P=R[I|−t]=K⁻¹[p₁ p₂ p₃ p₄]=K⁻¹[h₁ h₂ p₃ h₃].

The two first columns in the rotation matrix R are equivalent to the two first columns of K⁻¹H. Denote these two column with r₁ and r₂, and we get:

[r₁ r₂]=K⁻¹[h₁ h₂].

Since the rotation matrix is orthogonal, r₁ and r₂ should be orthogonal and of unit length. However, as we have mentioned before, H is only determined up to scale, which means that r₁ and r₂ will not be normalized, but they should still be of the same length.

Conclusion: With a calibrated camera we obtain two additional constraints on H:

r₁^{T}r₂=0

|r₁|=|r₂|,

where

[r₁ r₂]=K⁻¹[h₁ h₂].

C. Solving for the Homography Matrix H

The first thing to consider, when solving the equation for the homography matrix H, is how many corresponding points x′ [symbol] x are needed. As we mentioned in section B, H has eight degrees of freedom. Since we are working in 2D, every point has constraints in two directions, and hence every point correspondence has two degrees of freedom. This means that a lower bound of four corresponding points in the two different coordinate frames is needed to compute the homography matrix H. This section will show different ways of solving the equation for H.

The Direct Linear Transformation (DLT) Algorithm

For every point correspondence, we have the equation x′ᵢ=Hxᵢ. Note that since we are working with homogeneous vectors, x′ᵢ and Hxᵢ may differ up to scale. The equation can also be expressed as a vector cross product x′ᵢ×Hxᵢ=0. This form is easier to work with, since the scale factor will be removed. If we denote the j-th row in H with h^{jT}, then Hxᵢ can be expressed as:

$${Hx}_{i} = ( \begin{matrix}{h}^{1 T} {x}_{i} \\ {h}^{2 T} {x}_{i} \\ {h}^{3 T} {x}_{i}\end{matrix} ) .$$

Using the same terminology as in section B, the cross product above can be expressed as:

$${x}_{i}^{′} \times {Hx}_{i} = ( \begin{matrix}{y}_{i}^{′} {h}^{3 T} {x}_{i} - {w}_{i}^{′} {h}^{2 T} {x}_{i} \\ {w}_{i}^{′} {h}^{1 T} {x}_{i} - {x}_{i}^{′} {h}^{3 T} {x}_{i} \\ {x}_{i}^{′} {h}^{2 T} {x}_{i} - {y}_{i}^{′} {h}^{1 T} {x}_{i}\end{matrix} ) = 0.$$

Since h^{jT}xᵢ=xᵢ^{T}h^{j} for j=1 . . . 3, we can rearrange the equation and obtain:

$${x}_{i}^{′} \times {Hx}_{i} = ( \begin{matrix}{0}^{T} & - {w}_{i}^{′} {x}_{i}^{T} & {y}_{i}^{′} {x}_{i}^{T} \\ {w}_{i}^{′} {x}_{i}^{T} & {0}^{T} & - {x}_{i}^{′} {x}_{i}^{T} \\ - {y}_{i}^{′} {x}_{i}^{T} & {x}_{i}^{′} {x}_{i}^{T} & {0}^{T}\end{matrix} ) ( \begin{matrix}{h}^{1} \\ {h}^{2} \\ {h}^{3}\end{matrix} ) = 0.$$

We are now facing three linear equations with eight unknown elements (the nine elements in H minus one because of the scale factor). However, since the third row is linearly dependent on the other two rows, only two of the equations provide us with useful information. Therefore every point correspondence gives us two equations. If we use four point correspondences we will get eight equations with eight unknown elements. This system can now be solved using Gaussian elimination.

Another way of solving the system is by using SVD, as will be described below.

Singular Value Decomposition (SVD)

In real life we usually don't get the position of the points to be exact, because of noise in the image. The solution to H will therefore be inexact. To get an H that is more accurate, we can use more than four point correspondences and then solve an over-determined system. If, on the other hand, the points are exact, the system will give rise to equations that are linearly dependent of each other, and we will once again end up with eight equations that are linearly independent.

If we have n numbers of point correspondences, we can denote the set of equations with Ah=0, where A is a 2n×9 matrix, and

$$h = ( \begin{matrix}{h}_{1} \\ {h}_{2} \\ {h}_{3}\end{matrix} )$$

One way of solving this system is by minimizing the Euclidian norm ∥Ah∥ instead, subject to the constraint ∥h∥=k, where k is a non-zero constant. This last constraint is because H is homogeneous. Minimization of the norm ∥Ah∥ is the same as optimizing the problem:

$${min}_{‖ h ‖ = 1} A h .$$

A solution to this problem can be obtained by SVD. A detailed description of SVD is given in Golub, G. H., and Van Loan, C. F., “Matrix Computations”, 3d ed., The John Hopkins University Press, Baltimore, Md., 1996.

Using SVD, the matrix A can be decomposed into:

A=USV^{T},

where the last column of V gives the solution to h.

Restrictions on the Corresponding Points

If three points, out of the four point correspondences, are collinear, they will give rise to an underdetermined determined system (see Hartley, R., and Zissermann, A., “Multiple View Geometry in computer vision”, Cambridge University Press, 2000, page 74), and the solution from the SVD will be degenerate. We will therefore be restricted, when we pick our feature points, not to choose collinear points.

D. Feature Restrictions

An important question is how to find features in objects. Since the results preferably are supposed to be applicable on already existing signs, it is desired to find features that are common in use and easy to detect in an image. A good feature should fulfill as many of the following criteria as possible:

Be easy to detect,

Be easy to distinguish,

Be located in a useful configuration.

In this section, a few different kinds of features, that can be used to compute the homography matrix H, are found. The features should somehow be associated with points, since point correspondences are used to compute H. Feature finding programs, where the user can just change a few constants, stored in the object feature definition area 23 in the storage means 21, so as to adapt the feature finder for specific objects, are implemented according to the present invention.

A very common feature in most signs is lines in different combinations. Most signs are surrounded by an edge, which gives rise to a line. A lot of signs even have frames around them, which gives rise to double lines that are parallel. Irrespective of what kind of features that are found, it is important to gather as much information out of every single feature as possible. Since lines are commonly used features, a description of how to find different kind of lines will be given in section E.

Number of Features

Since the pictures are of 2D planes and are captured by a hand-held camera 300, the scene and image planes are related by a plane projective transformation. In section C it was concluded that at least four point correspondences are needed to compute H. If four points in the scene plane and the four corresponding points in the image are found, then H can be computed. The problem is that we do not know if we have the correct corresponding points. Therefore, a verification procedure to check whether H is correct has to be performed. To do this, H can be verified with even more point correspondences. If the camera is calibrated, a verification of H with the inner parameters 24 of the camera can be performed, as explained at the end of section B.

Restrictions on Lines

In 2D, lines have two degrees of freedom, and, in similarity with points, four lines—where no three lines are concurrent—can be used to compute the homography matrix. However, the calculation must be modified a little bit, since lines are transformed as l′=H^{-T}l, as opposed to points that are transformed as x′=Hx, for the same homography matrix H (see Hartley, R., and Zissermann, A., “Multiple View Geometry in computer vision”, Cambridge University Press, 2000, page 15).

It is even possible to mix feature points and lines when computing the homography matrix. There are however some more constraints involved while doing this, since points and lines are dependent of one another. As have been shown in section C, four points and similarly four lines hold eight degrees of freedom. Three lines and one point is geometrically equivalent to four points, since three non-concurrent lines define a triangle, and the vertices of the triangle uniquely define three points. Similarly, three non-collinear points and one line are equivalent to four lines, which have eight degrees of freedom. However, two points and two lines cannot be used to compute the homography matrix. The reason is that a total of five lines and five points can be determined uniquely from the two points and the two lines. The problem, however, is that four out the five lines are concurrent, and four out of the five points are collinear. These two systems are therefore degenerate and cannot be used to compute the homography matrix.

Choose Corner Points

In the preferred embodiment, the equation of the lines is not used when computing the homography matrix. Instead, the intersections of the lines are computed, and thus only points are used in the calculations. One of the reasons for doing this is because of the proportions of the coordinates (a, b and c) in the lines. In an image of VGA resolution, the values of the coordinates of a normalized line (see next section) will be

0≦|a|,|b|≦1,

but

0≦|c|≦\sqrt{640²+480²}=800.

This means that the c coordinate is not in proportion with the a and b coordinates. The effect of this is that a slight variation of the gradient of the line (i.e., the a and b coordinates) might result in a large variation of the component c. This makes it hard to verify line correspondences.

The problem with these proportionate coordinates does not disappear when the intersection points of the lines are used instead of the parameters of the lines, it has just moved. This is just a way to normalize the parameters, so they easily can be compared with each other in the verification procedure.

E. Line Detection

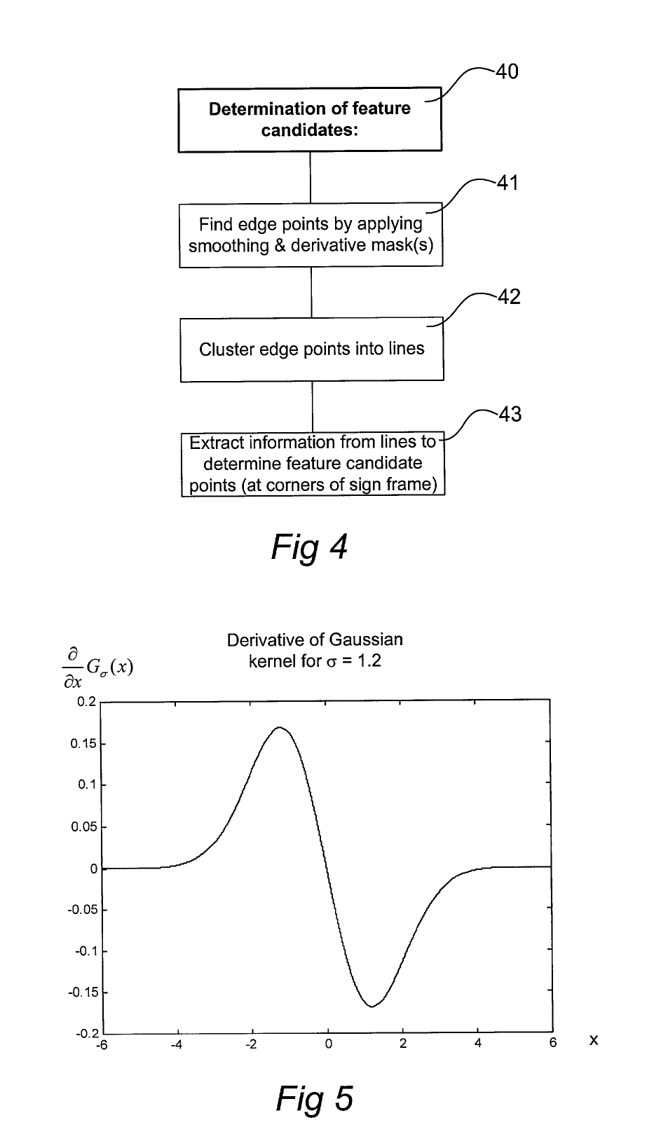

With reference to FIGS. 4 and 5, details about how to determine feature point candidates (i.e., step 33 in FIG. 33) will now be given. Steps 41 and 42 of FIG. 4 are described in this section, whereas step 43 will be described in the next section.

Edges are defined as points where the gradients of of the image are large in terms of gray-scale, color, intensity or luminescence. Once all the edge points in an image have been obtained, they can be analyzed to see how many of them lie on a straight line. These points can then be used as the foundations of a line.

Edge Points Extraction

There are several different ways of extracting points from the image. Most of them are based on thresholding, region growing, and region splitting and merging (see Gonzalez, R. C., and Woods, R. E., “Digital Image Processing”, Addison Wesley, Reading, Mass., 1993, page 414). In practice, it is common to run a mask through the image. The definition of an edge is the intersection of two different homogeneous regions. Therefore, the masks are usually based on computation of a local derivative operation. Digital images generally absorb an undeterminded amount of noise as a result of sampling. Therefore, a smoothing mask is also preferred before the derivative mask to reduce the noise. A smoothing mask, which gives very nice results, is the Gaussian kernel G_{σ}:

$${G}_{σ} ( x ) = \frac{1}{\sqrt{2 π {σ}^{2}}} {ⅇ}^{- {x}^{2} / 2 {σ}^{2}} ,$$

where σ is the standard deviation (or the width of the kernel) and x is the distance from the point under investigation.

Instead of first running a smoothing mask over the image and then take its derivate, it is advantageous to just take the convolution of the image with the derivative of the Gaussian kernel:

$$\frac{\partial }{\partial x} {G}_{σ} ( x ) = - \frac{x}{{σ}^{2}} \frac{1}{\sqrt{2 π {σ}^{2}}} {ⅇ}^{- {x}^{2} / 2 {σ}^{2}} .$$

FIG. 5 shows

$$\frac{\partial }{\partial x} {G}_{σ} ( x )$$

for σ=1.2.

Since images are 2D, the filter is used in both the x and the y directions. To distinguish the edge points n, the filtered points f(n), i.e. the result of the convolution of the image with the derivative of the Gaussian kernel, are selected, where

$$f ( n ) > \{ \begin{matrix}f ( n - 1 ) \\ f ( n + 1 ) \\ thres\end{matrix} ,$$

where thres is a chosen threshold.

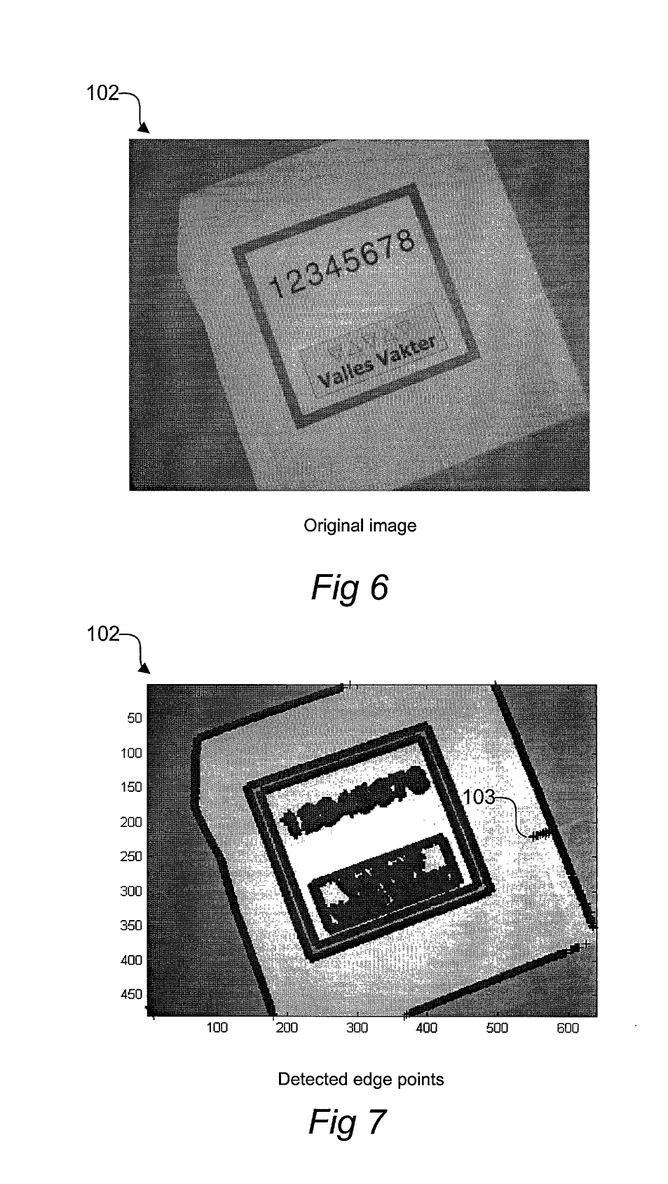

In FIG. 7, all the edge points detected from an original image 102 (FIG. 6) are marked with a “+” sign, as indicated by reference numeral 103. A Gaussian kernel with σ1.2 and thres=5 has been used here.

Extraction of Line Information

Once all the edge points have been obtained, it is possible to find the equation of the line they might be a part of. The gradient of a point in the image is a vector that points in the direction, in which the intensity in the image at the current point decreases the most. This vector is in the same direction as the normal to the possible line. Therefore, the gradient of all edge points has to be found. To extract the x coefficient of the edge point, the derivative of the Gaussian kernel in 2D,

$$\frac{\partial }{\partial x} {G}_{σ} ( x , y ) = - \frac{x}{2 π {σ}^{4}} \cdot {ⅇ}^{- ( {x}^{2} + {y}^{2} ) / 2 {σ}^{2}} ,$$

is applied to the image around the edge points. In this mask, (x,y) is the distance from the edge point.

$$\text{Typically a range of} \{ \begin{matrix}- 3 σ < x < 3 σ \\ - 3 σ < y < 3 σ\end{matrix} \text{is used,}$$

where σ is the standard deviation.

Similarly, the y coefficient can be extracted. As mentioned above, the normal of the line has the same direction as the gradient. Hence, the a and b coefficients of the line have been obtained. The last coordinate c can easily be computed, since ax+by+c=0. Preferably, the equation for the line will be normalized, so the normal of the line will have the length 1:

$$I = \frac{{( a , b , c )}^{T}}{\sqrt{( {a}^{2} + {b}^{2} )}} .$$

This means that the c coordinate will have the same value as the distance from the line to the origin.

Cluster Edge Points into Lines

To find out if edge points are parts of a line, constraints on the points have to be applied. There are two major constraints:

The points should have the same gradient.

The proposed line should run through the points.

Since the image will be blurred, these constraints must be fulfilled only within a limit of a certain threshold. The threshold will of course depend on under what circumstances the picture was taken, the resolution of the image, and the object in the picture. Since all the data for the points is known, all that has to be done is to group the points together and adapt lines to them (step 42 in FIG. 4). The following algorithm is used according to the preferred embodiment:

For a certain amount of loops,

Step 1: Select randomly a point p=(x,y,1)^{T}, with the line data l=(a,b,c)^{T};

Step 2: Find all other points pₙ=(xₙ,yₙ,1)^{T}, with the line data lₙ=(aₙ,bₙ,cₙ)^{T}, which lie on the same line using:

pₙ^{T}·l<thres1;

Step 3: See if these points have the same gradient as p using: (aₙ,bₙ)·(a,b)^{T}>(1−thres2);

Step 4: From all the points that satisfy the conditions in step 2 and step 3, pₙ, adapt a new line, l=(a,b,c)^{T}, using SVD. Repeat step 2-3;

Step 5: Repeat step 2-4 twice;

Step 6: If there are at least a certain amount of points that satisfy these conditions, define these points to be a line;

End. Repeat with the Remaining Points.

This algorithm selects a point by random. The equation of the line that this point might be a part of is already known. Now, the algorithm finds all other points that have the same gradient and lie on the same line as the first point. Both these checks have to be carried out within a certain threshold. In step 2, the algorithm checks if the point is closer than the distance thresl to the line. In step 3, the algorithm checks if the gradients of the two points are the same. If they are, then the product of the gradients should be 1. Once again, because of inaccuracy, it is sufficient if the product is larger than (1−thres2). Since the edge points are not exactly located, and since the gradients will not have the exact value, a new line is computed in step 4. This line is computed from all the points, which satisfy the conditions in step 2 and step 3 using SVD, in the following way. The points are also supposed to satisfy the condition (x,y,1)(a,b,c)^{T}=0. Therefore, an n×3 matrix consisting of these points can be composed, and the optimization of

$${min}_{‖ l ‖ = 1} A l ,$$

using SVD in similarity with section C. To obtain better accuracy, step 2 and step 3 are repeated. To increase the accuracy even further, one more recursion takes place. The values of the threshold numbers will have to be decided depending on an actual application, as is readily realized by a man skilled in the art.

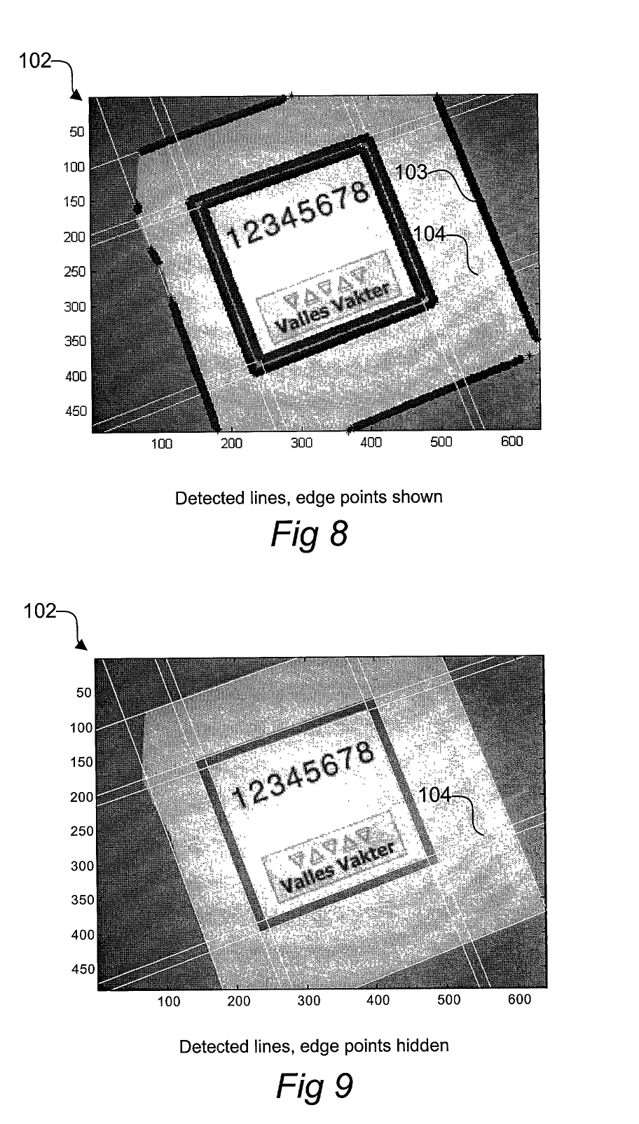

FIG. 8 shows the lines 104 that were found, and the edge points 103 that were used in the example above.

If the used edge points are left out, it is easier to see how good of an approximation the estimated lines are, see FIG. 9.

F. Information Gained from Lines

To compute the homography matrix H, four corresponding points, from the two coordinate frames, are needed. Since many lines are available, additional information can be provided.

Cross Points

Common features in signs are corners. However, there are usually a lot of corners in a sign that are of no interest; for instance, if there is text in the sign, the characters will give rise to a lot of corners that are of no interest. Now, when the lines that are formed by edges have been obtained, the corner points of the edges can easily be computed (step 43 of FIG. 4) by taking the cross product of two lines:

x_{c}=lᵢ×lⱼ.

The vector x_{c} will be the homogeneous representative of the point in which the lines lᵢ and lⱼ intersect. If the third coordinate of x_{c}=0, then x_{c} is the point at infinity, and the lines lᵢ and lⱼ are parallel.

These cross points, combined with the information from the lines, will provide even more information. A verification whether the lines actually have edge points at the cross points, or whether the intersection is in the extension of the lines, can be applied. This information can then be compared with the feature points searched for, since information is known as regards whether or not they are supposed to have edge points at the cross points. In this way, cross points that are of no interest can be eliminated. Points that are of no interest can be of different origin. One possibility is that they are cross points that are supposed to be there, but are not used in this particular case. Another possibility is that they are generated by lines, which are not supposed to exist but which nevertheless have originated because of disturbing elements in the image.

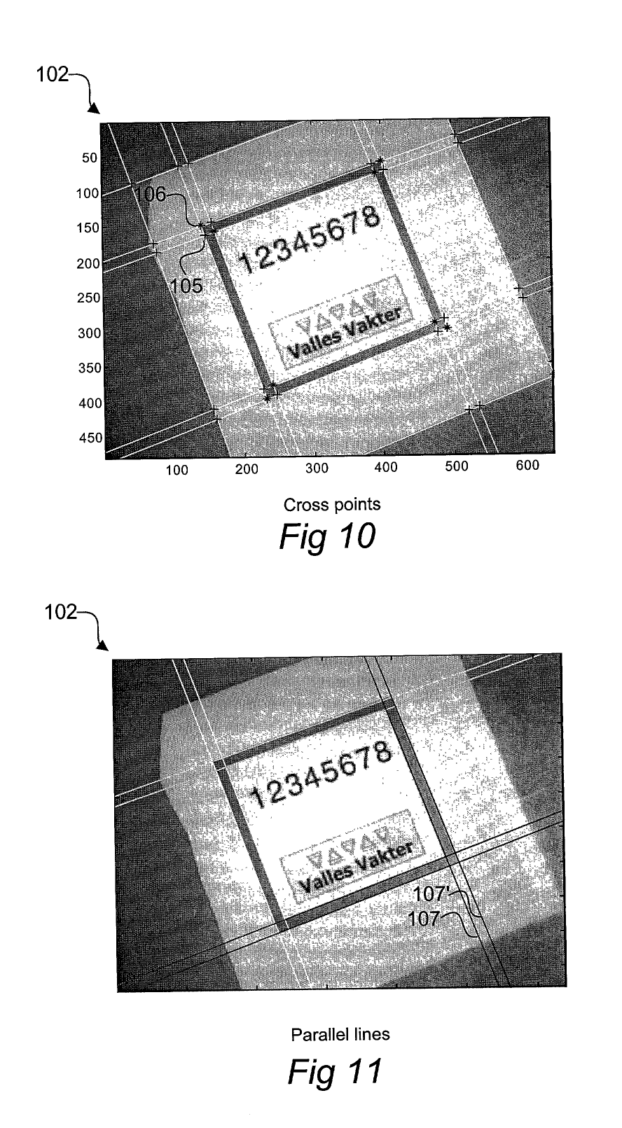

In FIG. 10, all cross points are marked with a “+” sign, as seen at 105. The actual corners of the frame are marked with a “*” sign, as seen at 106.

Parallel Lines

Another common feature in signs is frames, which give rise to parallel lines. If only lines originating from frames are of interest, then all lines can be discarded that do not have a parallel counterpart, i.e. a line with a normal in the opposite direction close to itself. Since the image is transformed, parallel lines in the 3D world scene might not appear to be parallel in the 2D image scene. However, lines which are close to each other will still be parallel within a certain margin of error. The result of an algorithm that finds parallel lines 107, 107′ is shown in FIG. 11.

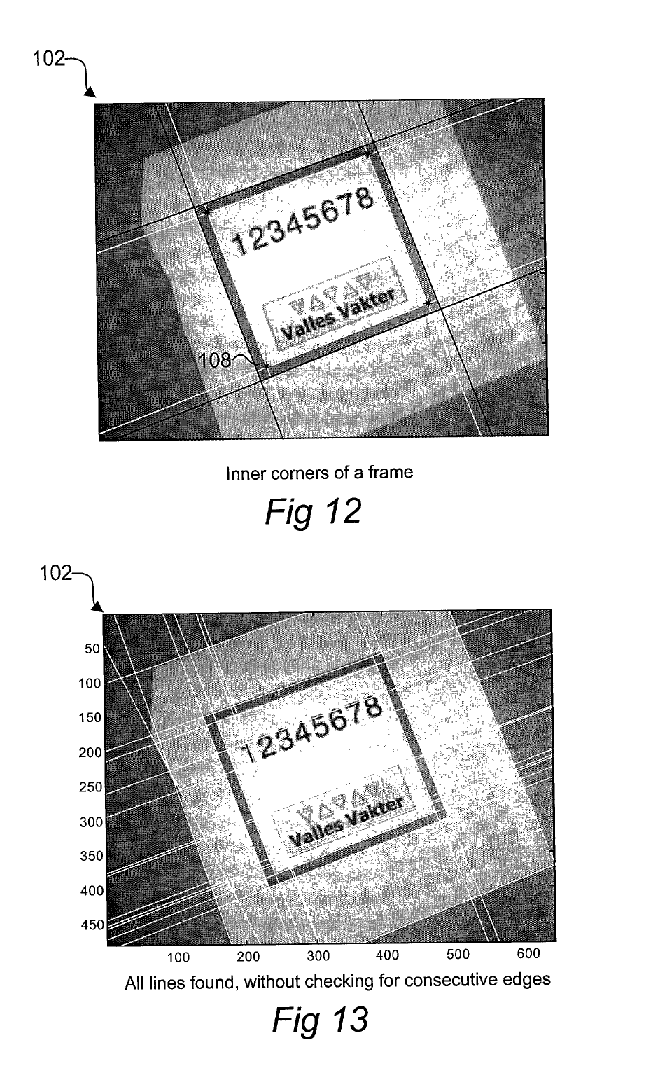

When all the sets of parallel lines have been found, it is possible to figure out which lines that are candidates of being a line corresponding to the inside edge of a frame. If the cross products of all these lines is computed, a set of points that are putative candidates of inside corner points in a frame is obtained, as marked by “*” characters at 108 in FIG. 12.

Consecutive Edge Points

By coincidence, it is possible that the line-detecting algorithm produces a line that is actually made up from a lot of small edges that lie on a straight line. For example, edges of characters written on a straight line may give rise to such a line. If only lines consisting of consecutive edge points are of interest, it is desired to eliminate these other lines. One way of doing this is to take the mean point of all the edge points in the line. From this point, extrapolate a few more points along the line. Now check the differences in intensity on both sides of the line at the chosen points. If the differences in intensities at the points do not exceed a certain threshold, the line is not constructed from consecutive edge points.

With this algorithm, not only lines that originate from non-consecutive edge points will be eliminated, the algorithm will also eliminate thin lines in the image. This is a positive effect, if only edge lines originating from thick frames are used as features. In FIG. 13, the same algorithms as used earlier have been applied to the image 102 displayed in FIG. 6. The only difference in the algorithms is that no check has been carried out as regards whether the lines consist of consecutive edge points along edges.

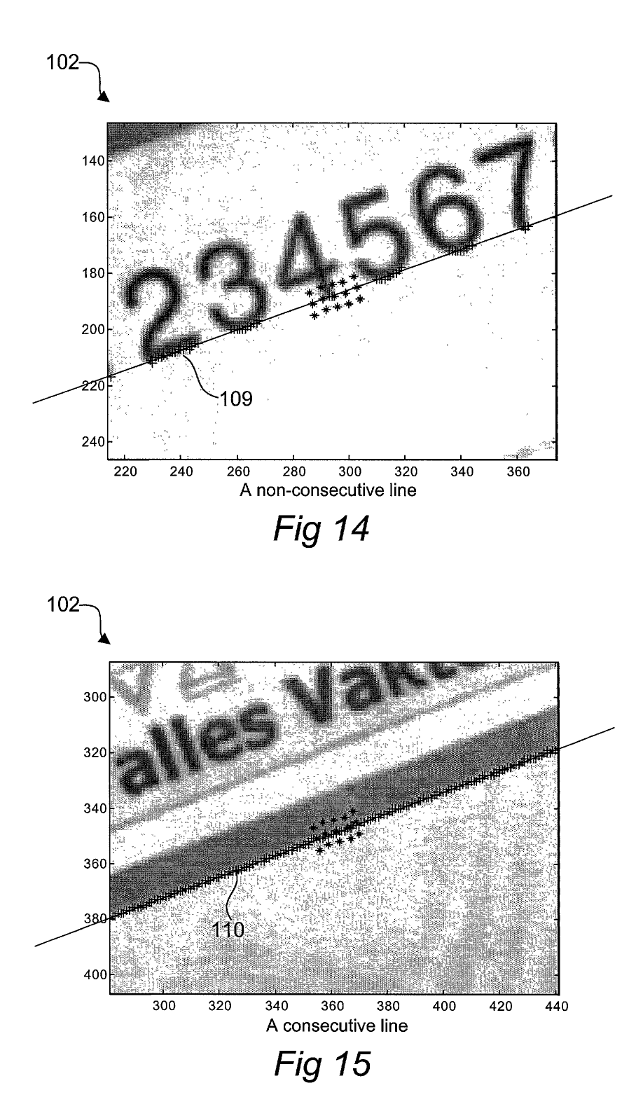

FIG. 14 shows an enlargement of the result of the algorithm, which checks for consecutive edge points, applied to the line 109 at the bottom of the numbers “12345678”. The algorithm gave a negative result, in terms of whether it was consecutive edge points or not. FIG. 15 is an enlargement of the same algorithm applied to the line 110 at the bottom of the frame. Here, the algorithm gave a positive result of the edge points being consecutive.

G. Computing the Homography Matrix H

Once the feature candidates in the image have been obtained, they must be matched to features from the original sign, which have known coordinates. If four feature candidates have been found, their coordinates can be matched with the corresponding object feature point coordinates stored in the area 23 of the storage means 21, and the homography matrix H can be computed. Since probably more candidates to the interesting features than the intended ones will be found, a verification procedure has to be carried out. This procedure must verify that the selected feature point correspondences have been carried out with the correct matching. Thus, if there are a lot of candidates for possible feature points, the homography matrix should be computed many times and verified every time, to check whether it is the proper point correspondence or not.

Advantageously, this matching procedure is optimized by using the RANSAC algorithm of Fischler and Bolles (see Fischler, M. A., and Bolles, R. C., “Random sample consensus: A paradigm for model fitting with applications to image analysis and automated cartography”, Comm. Assoc. Comp. Mach., 24(6):381-395, 1981).

RANSAC

The RANdom SAmple and Consensus algorithm (RANSAC) is an estimating algorithm that is able to work with very large sets of putative correspondences. The best way to determine the homography matrix H is to compute H for all possible combinations, verify every solution, and then use the correspondence with the best verification. The verification procedures can be done in different ways, as is described below. Since computing H for every possible combination is very time consuming, this is not a very good approach when the algorithms are supposed to be carried out in real-time. The RASAC algorithm is also a hypothesis-and-verify algorithm, but it works in a different way. Instead of systematically working itself through the possible feature points, it selects its correspondence points randomly and then computes the homography matrix and performs the verifications. RANSAC is supposed to repeat this procedure for a certain amount of times and then decide to use the correspondence set with the best verification.

The advantages of the RANSAC procedure is that it is more robust when there are many possible feature points, and it tests the correspondences in a random order. If the point correspondences are tested in a systematical order and the algorithm accidentally starts with a point that is incorrect, then all the correspondences, that this point might give rise to, has to be verified by the algorithm. This does not happen with RANSAC, since one point will only be matched with one possible point correspondence, and then new feature points will be selected to match with each other. The RANSAC matching procedure is only done a specific amount of times, and then the best solution is selected. Since the points are chosen randomly, sometimes the proper match, or at least one that is close to the correct one, have been chosen, and then these point correspondences can be used to compute H.

Verification Procedures

Once the homography matrix has been computed, it has to be verified that the correct point correspondences have been used. This can be done in a few different ways.

A 5^{th} Feature

The most common way to verify H is by using more feature points. In this case, even more than the four feature points from the original objects have to be known. The remaining points from the original object can then be transformed into the image coordinate system. Thereafter, a verification procedure can be performed to chech whether the points have been found in the image. The more extra features that are found, the higher likelihood that the correct set of point correspondences have been picked.

Inner Parameters of Camera

If the camera is calibrated, it is possible to verify the putative homography matrix with the inner camera parameters 24 stored in the storage means 21 (see discussion in earlier sections). This puts even more constraints on the chosen feature points. If the points represents the corners of a rectangle, then the first and second row, r₁ and r₂, will give rise to the same value if the points are matched correctly up to an error of rotation of the rectangle of 180 degrees. This is obvious, since if a rectangle is rotated 180 degrees, it will give rise to exactly the same rectangle. Similarly, a square can be rotated 90, 180 or 270 degrees and still give rise to exactly the same square. In all these cases, r₁ and r₂ will still be orthogonal.

Although this verification procedure might give a rotation error, if the corners of a rectangle are used as feature points, it is still very useful, since rectangles are common features. The rotation error can easily be checked later on.

Verification Errors

Depending on how the feature points are chosen, there may still occur errors when the feature points are being verified. As mentioned above, the nomography matrix is a homogenous matrix and is only determined up to a scale. If the object have points that are at the exact same configuration as the feature-and-verification points, except rotated and/or up to scale, the verification procedure will give rise to exactly the same values as if the correct point correspondences had been found. Therefore it is important to choose feature points that are as distinct as possible.

Restrictions on RANSAC

RANSAC is based on randomization. If even more information is available, then obviously this should be used to optimize the RANSAC algorithm. Some restrictions that might be added are the following.

Stop if the Solution is Found

Instead of repeating the calculations in the procedure a specific amount of times, it is possible to stop, if the verification indicates that a solution that is good has been found. To determine if a solution is good or not, a statement can be made that if at least a certain amount of feature points in the verification procedure have been found, then this must be the correct nomography matrix. If the inner parameters of the camera are used as the verification procedure, a stop can be made if r₁ and r₂ are very close to having the same length and being orthogonal.

Collinear Feature Points

The constraint that only such a set of feature points are supposed to be used, where no three points are allowed to be collinear, can be included in the RANSAC algorithm. After the four points have been picked by randomization, it is possible to check if three of them are collinear, before proceeding with computing the homography matrix. Combined with the next two restrictions, this check is very time efficient.

Convex Hull

The convex hull of an arbitrary set S of points is the smallest convex polygon P_{ch} for which each point in S is either on the boundary of P_{ch} or in its interior. Two of the most common algorithms used to compute the convex hull are Graham's scan and Jarvis's march. Both these algorithms use a technique called “rotational sweep” (see Cormen, T. H., Leiserson, C. E., and Rivest, R. L., “Introduction to Algorithms”, The Massachusetts Institute of Technology, 1990., page 898). When computing the convex hull, these algorithms will also provide the order of the vertices, as they appear on the hull, in counter-clockwise order. Graham's scan runs in O(n1gn) time, as opposed to Jarvis's march that runs in O(nh) time, where n is the number of points and h is the number of vertices.

Since projective mappings are line preserving, they must also preserve the convex hull. In a set of four points, where no three points are collinear, then the convex hull will consist of either three or four of the points. This means that in two sets of corresponding points, their convex hull will both consist of either three or four points. A check for this, after the two sets of four points have been chosen, can be included in the RANSAC algorithm.

Systematic Search

The principle of PANSAC is to choose four points by randomization, match them with four putative corresponding points also chosen by randomization and then discard these points and choose new ones. It is possible to modify this algorithm and include some systematical operations. Once the two sets of four points have been selected, all the possible combinations of matching between these points can be tested. This means that there are 4!=24 different combinations to try. If the restrictions above are included, this number can be reduced considerably. First of all, make sure that no three of the four points in each set are collinear. Secondly, check if both the sets have the same amount of points in the convex hull. If they do, the order of the points on the hull will also be obtained, and now the points can only be matched with each other on either three or four different ways depending on how many points the hulls consist of.

Thus, out of 24 possible combinations, 0, 3 or 4 putative point correspondences has been reached. Of course, computing the convex hull and making sure that no three points are collinear is time consuming, but it is insignificant compared to computing the homography matrix 24 times.

Another method of reducing the computing time is to suppose that the image is taken more or less perpendicular to the target. Thus, lines which cross each other at 90 degrees will cross each other at an angle close to 90 degrees in the image. By looking for such almost perpendicular lines, it is possible to rapidly determine lines suitable for the transformation. If no such lines are found, the system continues as outlined above.

It is often time and processing power consuming to find and extract lines from an image. For the purpose of the present invention, the computation time may be decreased by downsampling of the image. Thus, the image is divided by a grid comprising for example each second line of pixels in the x and y directions. The presence of a line on the grid is determined by testing only pixels on the grid. The presence of a line may then be verified by testing all pixels along the supposed line.

H. Extraction of the Target Area

Once the homography matrix is known, any area from the image can be extracted, so it will seem like the picture was taken from a place located right in front of it. To do this extraction, all the points from within the area of interest will be transformed to the image plane in the resolution of choice. Since the image is a discrete coordinate frame, it is made up of pixels with integer numbers. The transformed points will probably not be integers though. Therefore, a bilinear interpolation (see e.g. Heckbert, P. S., “Graphics Gems IV”, Academic Press, Inc. 1994) to obtain the intensity from the image has to be made. The transformed image can be recovered from either the gray-scale intensity, or all three intensity levels can be obtained from the original picture in color.

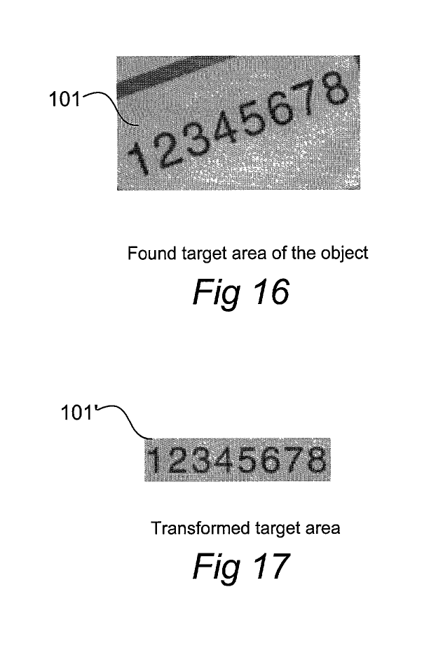

FIG. 16 shows the target area 101 of the image 102 in FIG. 6, found by the algorithms above.

In FIG. 17, the target area 101′ has been transformed, so that e.g. OCR or barcode interpretation can follow (steps 36 and 37 of FIG. 3). In this example, a resolution of 128 pixels in the x direction was chosen.

I. Alternative Embodiments

The invention has been described above with reference to an embodiment. However, other embodiments than the one disclosed above are equally possible within the scope of the invention, as defined by the appended patent claims. In particular, it is observed that the invention may be embodied in other portable devices than the one described above, for instance mobile telephones, portable digital assistants (PDA), palm-top computers, organizers, communicators, etc.

Moreover, it is possible, within the scope of the invention, to perform some of the steps of the inventive method in the external computer 200 rather than in the hand-held device 300 itself. For instance, it is possible to transfer the transformed target area 101 as a digital image (JPEG, GIF, TIFF, BMP, EPS, etc) across the link 301 to the computer 200, which then will perform the actual processing of the transformed target area 101 so as to extract the desired information (OCR text, barcode, etc.).

Of course, the computer 200 may be connected, in a conventional manner, to a local area network or a global area network such as Internet, which allows the extracted information to be forwarded to still other applications outside the hand-held device 300 and computer 200. Alternatively, the extracted information may be communicated through a mobile telephone, which is operatively connected to the hand-held device 300 by IrDA, Bluetooth or cable (not shown in the drawings).

While several embodiments of the invention have been described above, it is pointed out that the invention is not limited to these embodiments. It is expressly stated that the different features as outlined above may be combined in other manners than explicitely described and such combinations are included within the scope of the invention, which is only limited by the appended patent claims.

1. A method of extracting information from a target area within a two-dimensional graphical object having a plurality of predetermined features with known characteristics in a first plane, comprising the steps of:
reading an image in which said object is located in a second plane, said second plane being a priori unknown;
in said image, identifying a plurality of candidates to said predetermined features in said second plane;
from said identified plurality of feature candidates, calculating a transformation matrix for projective mapping between said second and first planes;
transforming said target area of said object from said second plane into said first plane, and
processing said target area so as to extract said information.

2. A method as claimed in claim 1, wherein said plurality of predetermined features are read from memory before said plurality of feature candidates are identified.

3. A method as claimed in claim 1, wherein said plurality of predetermined features includes at least four features.

4. A method as claimed in claim 3, wherein said at least four predetermined features are four points, four lines, three points and one line, or one point and three lines.

5. A method as claimed in claim 3, said at least four predetermined features being four points, wherein said plurality of feature candidates are identified by:
locating edge points as points in said image with large gradients;
clustering said edge points into lines; and
determining said plurality of feature candidates as points of intersection between any two of said lines.

6. A method as claimed in claim 5, wherein said points of intersection are at four corner points of a frame in said two-dimensional graphical object

7. A method as claimed in claim 1, wherein said transformation matrix is calculated by:
among said identified plurality of feature candidates, randomly selecting as many feature candidates as in said plurality of predetermined features;
computing a hypothetical transformation matrix for said randomly selected candidates and said plurality of predetermined features;
verifying the hypothetical transformation matrix;
repeating the above steps a number of times; and
selecting as said transformation matrix the particular hypothetical transformation matrix with the best outcome from the verifying step.

8. A method as claimed in claim 7, wherein the hypothetical transformation matrix is verified by means of at least one additional predetermined feature.

9. A method as claimed in claim 6, wherein said plurality of predetermined features comprises at least four points and wherein said step of randomly selecting is limited to a set of four feature candidates that does not include three collinear points.

10. A method as claimed in claim 9, wherein said step of randomly selecting is further limited by calculating the convex hull of said feature candidates.

11. A method as claimed in claim 1, wherein said plurality of predetermined features includes at least one point having a gray-scale, color, intensity or luminescence value which is distinctly different from surrounding points in said two-dimensional graphical object.

12. A method as claimed in claim 1, wherein said two-dimensional graphical object is a sign.

13. A method as claimed in claim 1, wherein said step of processing involves optical character recognition of said target area.

14. A method as claimed in claim 1, wherein said step of processing involves barcode interpretation of said target area.

15. A method as claimed in claim 1, wherein said step of processing involves transfer of said target area to an external computer.

16. A method as claimed in claim 1, wherein said first plane is the image plane of said read image.

17. A method as claimed in claim 1, wherein said first plane is the image plane of a previously read image.

18. A method as claimed in claim 1, wherein said plurality of predetermined features are obtained by direct measurement at said previously read image.

19. A computer program product directly loadable into an internal memory of a processing device, the computer program product comprising program code for performing the steps of any of claims 1-18 when executed by said processing device.

20. A computer program product as defined in claim 19, embodied on a computer-readable medium.

21. A hand-held image-producing apparatus having storage means and a processing device, the storage means containing program code for performing the steps of any of claims 1-18 when executed by said processing device.

22. An apparatus for extracting information from a target area within a two-dimensional graphical object having a plurality of predetermined features with known characteristics in a first plane, the apparatus comprising an image sensor, a processing device and storage means, comprising
a first area in said storage means, said first area being adapted to store an image, as recorded by said image sensor, in which said object is located in a second plane, said second plane being a priori unknown; and
a second area in said storage means, said second area being adapted to store said plurality of predetermined features; wherein:
said processing device being adapted to read said image from said first area; read said plurality of predetermined features from said second area; identify, in said image, a plurality of candidates to said features in said second plane; calculate, from said identified feature candidates, a transformation matrix for projective mapping between said second and first planes; transform said target area of said object from said second plane into said first plane; and, after transformation, extract said information from said target area.

23. An apparatus according to claim 22, further comprising an optical character recognition module adapted to extract said information from said target area.

24. An apparatus according to claim 22, further comprising a barcode interpretation module adapted to extract said information from said target area.

25. An apparatus according to claims 22 in the form of a hand-held device.

26. An apparatus according to claims 22, wherein said apparatus involves a hand-held device and a computer.

27. Use of a handheld apparatus according to claim 22 for extraction of information from an image taken by said handheld apparatus.
